(19) United States
(12) Patent Application Publication
(10) Pub. No.: US 2022/0155133 A1
(43) Pub. Date: May 19, 2022

(54) DIGITAL WEIGHT SCALE WITH CELLULAR COMMUNICATIONS

(71) Applicant: Smart Meter Corporation, Montabello, NY (US)

(72) Inventor: Benjamin Atkin, Miami, FL (US)

(73) Assignee: Smart Meter Corporation, Montabello, NY (US)

(21) Appl. No.: 17/517,866

(22) Filed: Nov. 3, 2021

Related U.S. Application Data
(60) Provisional application No. 63/113,565, filed on Nov. 13, 2020.

(51) Int. Cl. G01G 19/44; H04W 4/38; H04W 4/80; G01G 23/18

(52) U.S. Cl. CPC G01G 19/44; H04W 4/38; G06F 3/167; G01G 23/18; H04W 4/80

(57) ABSTRACT

A body weight scale is described. The body weight scale includes a load sensor that captures a body weight of an individual, an analog-to-digital converter that converts the body weight of the individual to a digital weight, a wireless communication interface that provides data communication connectivity to the network, a central computer processor (CPU) that is connected to a memory, the memory that stores user profiles, a display that displays information to the individual, a microphone that receives an audio input from the individual, and a voice activation component that includes one or more algorithms. The one or more algorithms are configured to: analyze the audio input, compare the audio input to commands stored in the memory, determine that the audio input corresponds to a command of the commands stored in the memory, and process and execute the command. The mobile device interacts with the scale via the network.

### CROSS-REFERENCE TO RELATED APPLICATIONS SECTION

This application is a U.S. Non-Provisional Patent Application that claims priority to U.S. Provisional Patent Application Ser. No. 63/113,565 filed on Nov. 13, 2020, the entire contents of which are hereby incorporated by reference in their entirety.

### FIELD OF THE EMBODIMENTS

The field of the invention and its embodiments relate to a digitial weight scale. In particular, the field of the invention and its embodiments relate to a digital weight scale with cellular communication capabilities.

### BACKGROUND OF THE EMBODIMENTS

Scales determine weight by measuring the amount of force required to oppose an object's acceleration due to gravity. Scales may be used to weigh raw materials, reagents, food items, and humans. Further, scales may be mechanical and digital. Mechanical scales typically use a spring, where, when weight is applied to the scale, measurement is shown by a moving dial. These scales allow for quick and easy-to-read measurements. Digital scales employ the use of a special electrical circuit. As a weight is applied to the digital scale, the voltage within the circuit changes and a processor calculates the weight. Digital scales are more accurate than mechanical scales, can provide multiple units of measure, and can often be connected to a computer for easy processing of data.

In the household setting, digital weight scales measure numerous health parameters of the individual, such as the weight, body mass index (BMI), body fat percentage, bone mass, and muscle mass, among others. However, such scales fail to provide additional functionality that is necessary for a user to track ones health and/or chronic health conditions.

### REVIEW OF RELATED TECHNOLOGY

U.S. Pat. No. 9,778,095 B2 describes a weighing device of the digital bathroom scale type that includes four feet, where each foot has a strain gauge. The scale also includes four conducting portions on the top surface and one electronic control unit. The electronic unit is configured to measure first signals indicative of periodic variations in weight and second signals indicative of periodic variations in impedance caused by the heartbeats of the user. The electronic unit is then configured to determine the heart rate of the user from the first and second signals.

U.S. Pat. No. 10,004,407 B2 describes a weighing scale apparatus. Specific embodiments concern an arrangement of devices configured and arranged to monitor physiological parameters while the user is standing on a platform region of the device and communicate an assessed fitness to the user as feedback.

U.S. Pat. No. 9,909,917 B2 describes a method of using an interactive body weight scale. The body weight scale may have computing and data communication ability to track a user's weight by connecting to a number of different electronic devices. The body weight scale is capable of recording an audio message, converting the audio message to message text, and transmitting the message to a remote social network. The scale may also receive message responses from the remote network and play the messages back based on whether a particular message is a positive message. A scale use indicator provides a reminder for a user to use the body weight scale.

U.S. Pat. No. 9,568,354 B2 describes weighing scale apparatuses. According to one such implementation, a weighing scale uses a base unit to integrate a support structure, a display, and circuitry to measure and determine the physiological parameters of the user, including a user-weight metric. The support structure includes a platform region that utilizes sensor circuitry to collect physiological data from the user, which is then processed by user-targeted circuitry to determine the physiological parameters (e.g., weight and heart-related measurements) of the user. Such parameters are then associated with the user and saved to a data-access circuit, and also forwarded to a display which communicates the physiological parameters among other information to the user through the platform region. The display encompasses substantially all of the platform region, including the region(s) upon which the user would stand for weight measurements.

Various scales exist. However, their means of operation are substantially different from the present disclosure, as the other inventions fail to solve all the problems taught by the present disclosure.

### SUMMARY OF THE EMBODIMENTS

The present invention and its embodiments relate to a digitial weight scale. In particular, the present invention and its embodiments relate to a digital weight scale with cellular communication capabilities.

A first embodiment of the present invention describes a system. The system includes a network, a body weight scale, and a mobile device. The body weight scale includes numerous components, such as, but not limited to: a load sensor configured to capture a body weight of an individual, an analog-to-digital converter configured to convert the body weight of the individual to a digital weight, and one or more sensors configured to measure biometric parameters of the individual.

The body weight scale also includes a wireless communication interface configured to provide data communication connectivity to the network and a central computer processor (CPU) connected to a memory. The memory is configured to house a first user profile associated with a first user and a second user profile associated with a second user. Each of the first and the second user profile comprise a weight log, images of food eaten by the first user or the second user during a given time period, and/or a unique identifier for the first user or the second user, among other information. More specifically, the weight log of each of the first user profile and the second user profile includes: a weight of the first user or the second user, an age of the first user or the second user, a height of the first user or the second user, an amount of body fat of the first user or the second user, a body mass index (BMI) of the of the first user or the second user, a goal or target weight of the first user or the second user, and/or a weigh-in date and time of the first user or the second user, among other information.

In some examples, in response to obtaining the digital weight of the individual, the body weight scale is configured to: compare the digital weight of the individual to a first group of weights associated with the first user profile, compare the digital weight of the individual to a second group of weights associated with the second user profile, determine that the digital weight is closer to the first group of weights associated with the first user profile of the first user, and predict the individual as being the first user. Using such method, the scale may predict which individual is engaging with the scale.

The body weight scale also includes a display configured to display information to the individual, a microphone configured to receive an audio input from the individual, and a voice activation component that includes one or more algorithms. The one or more algorithms of the voice activation component are configured to: analyze the audio input received via the microphone, compare the audio input to commands stored in the memory, determine that the audio input corresponds to a specific command of the commands stored in the memory based on the comparison, and process and execute the specific command.

In examples, the body weight scale also includes a data input device configured to receive a physical input from the individual. The system may also include a key fob, in examples. The key fob may contain wireless signal capabilities. The key fob is configured to transmit a signal to the scale when the key fob is within a proximity to the scale. In response to receiving the signal from the key fob, the scale is configured to: select a weight log corresponding to an owner of the key fob and store the digital weight of the individual in the first user profile if the owner of the key fob is the first user or store the digital weight of the individual in the second user profile if the owner of the key fob is the second user.

The mobile device is configured to interact with the scale via the network. The mobile device is also configured to send a signal via the network to the scale when the mobile device is in proximity to the scale. The scale, in response to receiving the signal from the mobile device, is configured to: select a weight log corresponding to an owner of the mobile device and store the digital weight of the individual in the first user profile if the owner of the mobile device is the first user or store the digital weight of the individual in the second user profile if the owner of the mobile device is the second user.

In additional examples, the mobile device includes a nutrition software application executed on the mobile device that is configured to track food data, weight data, and/or physical activity data of the individual.

A second embodiment of the present invention describes a body weight scale. The body weight scale includes numerous components, such as, but not limited to: a load sensor configured to capture a body weight of an individual, an analog-to-digital converter configured to convert the body weight of the individual to a digital weight, one or more sensors configured to measure biometric parameters of the individual, and a wireless communication interface configured to provide data communication connectivity to a network. The body weight scale is configured to communicate with a mobile device via the network.

The body weight scale also includes a CPU connected to a memory. The memory is configured to house a first user profile associated with a first user and a second user profile associated with a second user. Each of the first user profile and the second user profile comprise a weight log, images of food eaten by the first user or the second user in a given time period, and/or a unique identifier for the first user or the second user, among other information or components. Moreover, the weight log of each of the first user profile and the second user profile comprises: a weight of the first user or the second user, an age of the first user or the second user, a height of the first user or the second user, an amount of body fat of the first user or the second user, a body mass index (BMI) of the of the first user or the second user, a goal or target weight of the first user or the second user, and/or a weigh-in date and time of the first user or the second user, among other information or components.

Additionally, the body weight scale comprises a display configured to display information to the individual and a microphone configured to receive an audio input from the individual. In this embodiment, the audio input comprises login credentials. The body weight scale further includes: a voice activation component that includes one or more algorithms. The one or more algorithms of the voice activation component are configured to: analyze the login credentials of the individual received via the microphone, compare the login credentials of the individual to a first set of login credentials associated with the first user profile of the first user, compare the login credentials of the individual to a second set of login credentials associated with the second user profile of the second user, determine that the login credentials of the individual match the first set of login credentials associated with the first user profile of the first user, and confirm the identity of the individual as being the first user.

Moreover, the body weight scale includes: one or more indicators configured to drive adherence of scale use. Each of the one or more indicators comprise one or more light-emitting diodes (LEDs). Further, the first user is associated with a first color of light configured to be emitted from the one or more indicators and the second user is associated with a second color of light configured to be emitted from the one or more indicators. The first color of light differs from the second color of light. Additionally, the first color of light is stored in the first user profile and the second color of light is stored in the second user profile.

The one or more indicators are configured to project or flash the first color of light if the first user fails to use the body weight scale for a predetermined period of time. Also, the one or more indicators are configured to project or flash the second color of light if the second user fails to use the body weight scale for the predetermined period of time. In some examples, the one or more indicators comprise an audio functionality such that the one or more indicators project or flash light and/or emanate a sound when the individual is within a proximity of the scale.

In general, the present invention succeeds in conferring the following benefits and objectives.

The present invention describes a digitial weight scale with cellular communication capabilities.

The present invention describes a digital weight scale configured to interact via a wireless connection with a mobile device.

The present invention describes a voice activated digital weight scale.

The present invention describes a voice activated digital weight scale that pairs with the mobile device.

### BRIEF DESCRIPTION OF THE DRAWINGS

FIG. 1 depicts a block diagram of a system utilizing a body weight scale in a data communication network, according to at least some embodiments described herein.

FIG. 2 depicts a block diagram of components of a body weight scale, according to at least some embodiments described herein.

FIG. 3 depicts a block diagram of a memory component of a body weight scale, according to at least some embodiments described herein.

FIG. 4-FIG. 7 depict schematic diagrams of interactive displays for a body weight scale, according to at least some embodiments described herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

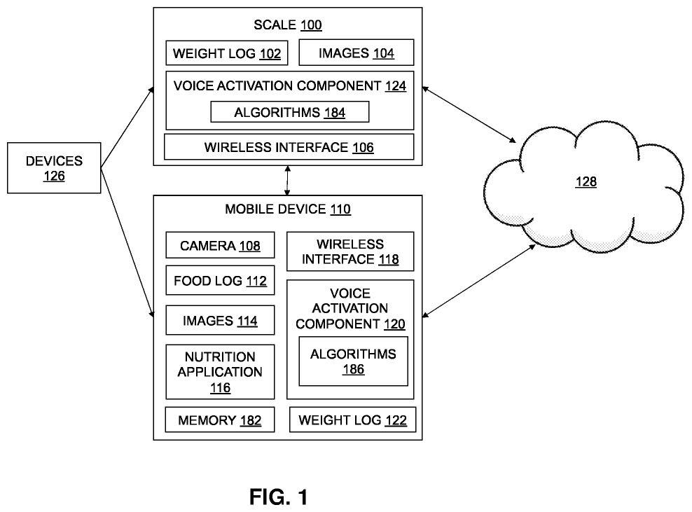

A system utilizing a body weight scale in a data communication network is depicted in at least FIG. 1. The system shown in FIG. 1 provides a comprehensive way for one or more individuals to track their weight and nutrition over time. The system of FIG. 1 includes a scale 100 (e.g., a body weight scale), a mobile device 110, and a data network 128. It should be appreciated that the scale 100 may accommodate over 500 pounds during weight measurements. The mobile device 110 may be a computer, a laptop computer, a smartphone, and/or a tablet, among other examples not explicitly listed herein.

Although the embodiment described in FIG. 1 depicts only two connected devices, the system of FIG. 1 may include a number of additional connected devices 126, providing data input to the scale 100, such as blood pressure cuffs, electrocardiogram (ECG) monitors, heart rate monitors, activity monitors, pedometers, and other such devices. These additional devices may also be connected to the mobile device 110, in examples. The additional connected devices 126 may also be part of a larger system of health tracking for the general wellness of the individual or to track chronic conditions, such as asthma, hypertension, diabetes, obesity, and others.

The scale 100 and the mobile device 110 each have wired or wireless data communication capabilities. The scale 100 may have a wireless interface 106 and the mobile device 110 may have a wireless interface 118. The wireless interface 106 and the wireless interface 118 may include one or more of Wi-Fi connections, Near Field (NFC) connections, Bluetooth® connections, Bluetooth® Low Energy (Bluetooth LE) connections, GSM or CDMA cellular communications, or other wireless protocols. It should be appreciated that the scale 100 and the mobile device 110 may each be capable of more than one type of wireless communication over the data network 128.

Wireless LANs (WLANs), in which a mobile user can connect to a local area network (LAN) through a wireless connection, may be employed for wireless communications. Wireless communications can include communications that propagate via electromagnetic waves, such as light, infrared, radio, and microwave. There are a variety of WLAN standards that currently exist, such as Bluetooth®, Bluetooth LE, and IEEE 802.11.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

As described herein, “NFC” is a set of communication protocols for communication between two electronic devices over a distance of 4 cm or less. NFC devices can act as electronic identity documents and keycards and may be used in contactless payment systems and allow mobile payment replacing or supplementing systems such as credit cards and electronic ticket smart cards. NFC can be used for sharing small files such as contacts, and bootstrapping fast connections to share larger media such as photos, videos, and other files.

As shown in FIG. 1, the scale 100 further includes a weight log 102, which includes weight information measured over a period of time for a given user/individual. In a preferred embodiment, the scale 100 includes multiple weight logs for multiple users of the scale 100. The scale 100 may identify and distinguish between different users of the scale 100 (such as a first user and a second user) in numerous ways, since each user's scale activity is tracked independently.

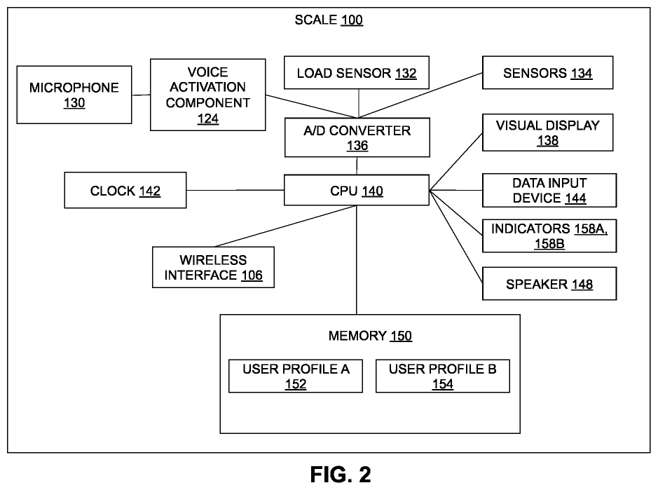

In a first example, the scale 100 may distinguish between the first user and the second user based on recognizing the weight of a given individual on the scale 100 and predicting the correct user based on the weight. More specifically, a load sensor 132 (of FIG. 2) of the scale 100 may capture a body weight of an individual. An analog-to-digital converter 136 (of FIG. 2) of the scale 100 converts the body weight of the individual to a digital weight. Then, the scale 100 is configured to compare the digital weight of the individual to a first group of weights associated with a first user profile A 152 (associated with a first user) (of FIG. 2) stored in a physical, non-transitory memory 150 (e.g., the memory 150) (of FIG. 2) of the scale 100 and compare the digital weight of the individual to a second group of weights associated with a second user profile B 154 (associated with a second user) (of FIG. 2) stored in the memory 150. The scale 100 is then configured to determine whether the digital weight is closer to the first group of weights associated with the first user profile A 152 or the second group of weights associated with the second user profile B 152. In an example where the scale 100 determines that the digital weight is closer to the first group of weights associated with the first user profile A 152, the scale 100 predicts that the individual is the first user. In other examples, the scale 100 is configured to determine that the digital weight is closer to the second group of weights associated with the second user profile B 154 and predict the individual as being the second user.

In another embodiment, the mobile device 110 may send a signal to the scale 100 when the mobile device 110 is in proximity to the scale 100. In this second embodiment, the scale 100 receives the signal from mobile device 110 and selects the weight log corresponding to the owner of the mobile device 110.

Alternately, a key fob (not shown) could contain wireless signal capabilities to send a signal to the scale 100 to select a particular weight log. It should be appreciated that a “key fob” is a security device with built-in authentication used to control and secure access to network services and data. Such key fob could also be used to signal to the scale 100 that a particular user is in close proximity to the scale 100, which could, in turn, signal the scale 100 to perform specific tasks unique to that scale user.

In another illustrative example, the scale 100 may distinguish between the first user and the second user based on login credentials of the given user. For example, when the given user (e.g., the first user) interacts with the scale 100, the first user may be prompted to provide login credentials to determine an identity of the given user engaging with the scale 100. Such login credentials may be provided to a microphone 130 (of FIG. 2) via audio input and/or via physical input through a data input device 144 (of FIG. 2) of the scale 100. The data input device 144 of the scale 100 may include a keyboard, mouse, touch screen, or other controller to allow the given user to input information into the scale 100. It should be appreciated that the login credentials are not limited to any particular type or configuration of credentials.

In the example where the first user provides the audio input, the microphone 130 of the scale 100 receives the login credentials via the audio input. Next, one or more algorithms 184 of a voice activation component 124 (of FIG. 1 and FIG. 2) of the scale 100 analyzes the login credentials to determine whether the login credentials corresponds to login credentials associated with a user profile stored in the memory 150 of the scale 100 (such as the first user profile A 152 associated with the first user or the second user profile B 154 associated with the second user). In response to a determination that the login credentials of the audio input correspond to the login credentials associated with the first user profile A 152, the one or more algorithms 184 of the voice activation component 124 confirm the identity of the user as the first user.

In the example where the user provides the login credentials via the physical input through the data input device 144, if the login credentials correspond to login credentials associated with a user profile stored in the memory, the identity of the given user is confirmed. If the identity of the given user is not confirmed via the audio input or the physical input, the given user is prompted to create a user profile on the scale 100 or the mobile device 110 via audio input and/or physical input. Responsive to creation of such profile, the created profile is stored in a memory 182 of the mobile device 110 and/or the memory 150 of the scale 100.

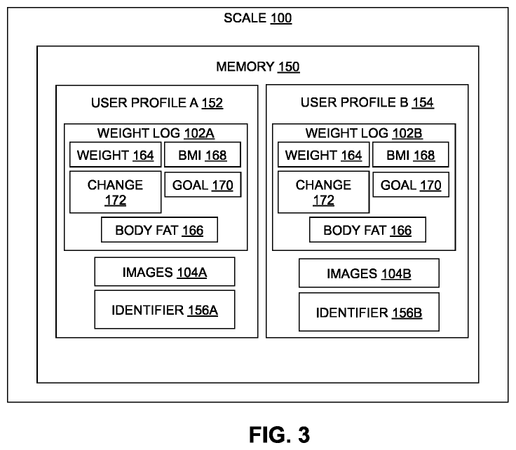

It should be appreciated that the weight log 102 may be updated with a new log entry every time a particular individual uses the scale 100. In an illustrative example, the weight log 102 may be updated with the new log entry every time the particular individual steps off the scale 100. Such weight log 102 may be updated multiple times a day, daily, weekly, monthly, etc. . . .As shown in FIG. 3, the weight log 102 may include information such as a weight 164 of the given user, an age of the given user, a height, an amount of body fat 166 of the given user, a body mass index (BMI) 168 of the given user, a goal or target weight 170 of the given user, a weigh-in date and time, and other physical health-related data of the given user. It should be appreciated that the BMI 168 is the person's weight in kilograms divided by the square of height in meters. A high BMI can be an indicator of high body fatness. BMI can be used to screen for weight categories that may lead to health problems. The health-related data is preferably measured and stored in weight log 102 at regular intervals, such as every time the given user weighs-in on the scale 100.

The scale 100 may communicate directly or indirectly with mobile device 110. In an example, a nutrition software application 116 (of FIG. 1) is executed on the mobile device 110. It should be appreciated that in other examples, the nutrition software application 116 may be an engine, a software program, a service, or a software platform executable on the mobile device 110. The user may input food information into the nutrition software application 116, which may be stored in a food log 112 (of FIG. 1). The nutrition software application 116 may also receive, from the user, weight data from the scale 100. In response, the nutrition software application 116 may store the weight data in a weight log 122 (of FIG. 1). It should be appreciated that the nutrition software application 116 may, in addition to tracking food and weight data, track physical activity data of the user. The nutrition software application 116 also allows the first user or the second user to share data and progress with another user, such as a workout partner or a trainer.

Specifically, in examples, the scale 100 may comprise a cellular modem (not shown) to communicate and/or transmit measurement results to the mobile device 110 or another computing device, such as a smartphone, a laptop computer, a tablet, or another suitable computing device. It should be appreciated that, as described herein, the cellular modem is a device that adds cellular connectivity to laptops, desktop computers, tablets, and other similar devices. Furthermore, it should be appreciated that the cellular modem (not shown) replaces the existing BLE module in the Bluetooth devices described herein.

In examples, the cellular modem may be embedded within the scale 100 or may be a standalone device that is connected to the scale 100 through various means, including, but not limited to, a USB connection. Examples of cellular modems include, but are not limited to, AT&T Momentum, Verizon 551 L, USB cellular modems and motherboard mounted cellular chipsets manufactured by Novatel Wireless, Sierra Wireless, Huawei, and the like. In other examples, the cellular modem may operate by switching between cellular and satellite communications.

Furthermore, the cellular modem may be configured to automatically connect to a slower network when the faster network is not available. The cellular modem may also monitor the reliability of all available connections. The reliability of a network can be determined from information collected by the cellular modem, which includes, but is not limited to, signal strength, quality, availability, packet loss, retransmits, packet latency, throughput speed, and other cell tower signaling quality factors. The cellular modem may then compare this information in various forms to a reliability threshold in order to determine whether or not to maintain or terminate a connection to a cellular network. The reliability threshold is often automatically set by the cellular carrier, or may be manually set by the user of the scale 100.

Further, it should be appreciated that the cellular modem is also configured to establish a connection with cellular networks in which the cellular modem is located. The cellular modem is configured to monitor and detect all cellular networks as the cellular modem moves from one network coverage area to another network coverage area via a vehicle in which it is contained. The cellular modem can detect when a connection to a particular network is made, whether it is a 3G, 4G, or 5G network, as well as which cellular network provider (e.g., Verizon, T-Mobile, etc.) it has connected to.

In some examples, the mobile device 110 comprises a digital camera 108 (of FIG. 1) that allows food images 114 (of FIG. 1) to be captured and stored in the memory 182 of the mobile device 110. In the preferred embodiment, the images 114 correspond to foods that the user has eaten, and each image 114 is associated in the food log 112 with one or more food log entries for a specific date and time. The scale 100 may receive the images 114 from the mobile device 110 and may store the images 114 as images 104 (of FIG. 1) in connection with the weight log 102 of scale 100. The images 104 may later be displayed to the scale user, as will be discussed herein.

A block diagram of components of the scale 100 is depicted in FIG. 2. The scale 100 contains numerous internal components for functioning within the system of FIG. 1. For example, the scale 100 includes a central computer processor (CPU) 140 connected to the physical, non-transitory memory 150 (e.g., the memory 150). A wireless communication interface 106 provides data communication connectivity to the data network 128 (of FIG. 1).

The memory 150 stores user data, such as water weight, lean weight, body fat percent, body mass index, etc.. The elements stored in memory 150 may be also synchronized and stored remotely in a cloud-based storage. Such data may be stored in the first user profile A 152 associated with the first user and in the second user profile B 154 associated with the second user. It should be appreciated that numerous profiles may be stored in the memory 150 and the quantity of the profiles is not limited to two.

As shown in FIG. 3, each of the user profiles (e.g., the first user profile A 152 and the second user profile B 154) may include a unique identifier associated with the user of the profile. For example, a first identifier 156A may be associated with the first user and may be stored in the first user profile A 152 and a second identifier 156B may be associated with the second user and may be stored in the second user profile B 154. For illustrative purposes only, the unique identifier may be a numerical code, an alphanumeric code, a username, etc.. Each of the first user profile A 152 and the second user profile B 154 may also include the weight log 102 unique to that user and images of food eaten by the specific user. Specifically, the first user profile A 152 may include a weight log 102A and the images 104A associated with the first user and the second user profile B 154 may include a weight log 102B and the images 104B associated with the second user.

The scale 100 may also include numerous sensors and input devices. For example, the scale 100 may include the load sensor 132 (of FIG. 2) that, as explained supra, captures the body weight, which is converted to the digital weight signal by the analog-to-digital converter 136 (of FIG. 2). The scale 100 may further include one or more sensors 134 (of FIG. 2). The one or more sensors 134 may include: body fat sensors, blood pressure cuffs, ECG monitors, heart rate monitors, and other such sensors for detecting physical and/or biometric measurements for a scale user. Moreover, as shown in FIG. 2, the scale 100 may include a speaker 148 and a visual display 138 that provides output and/or feedback to the user. The scale 100 may further comprises a clock 142 to determine weigh-in date and time for a particular scale user.

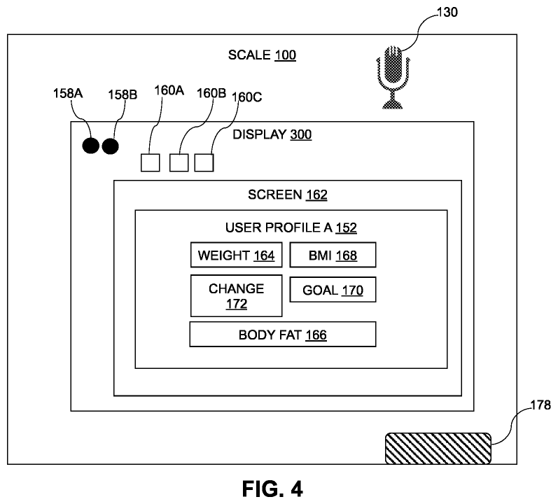

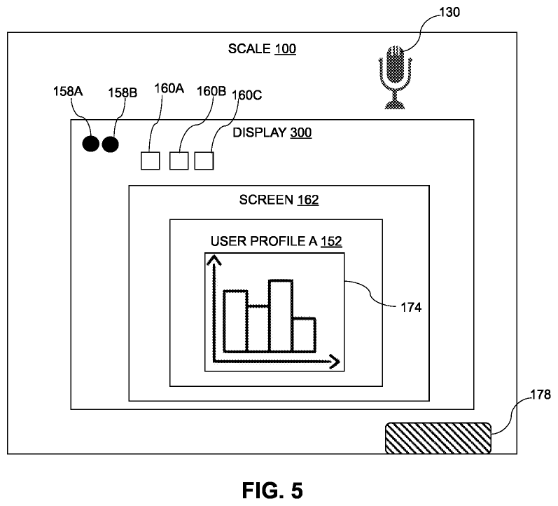

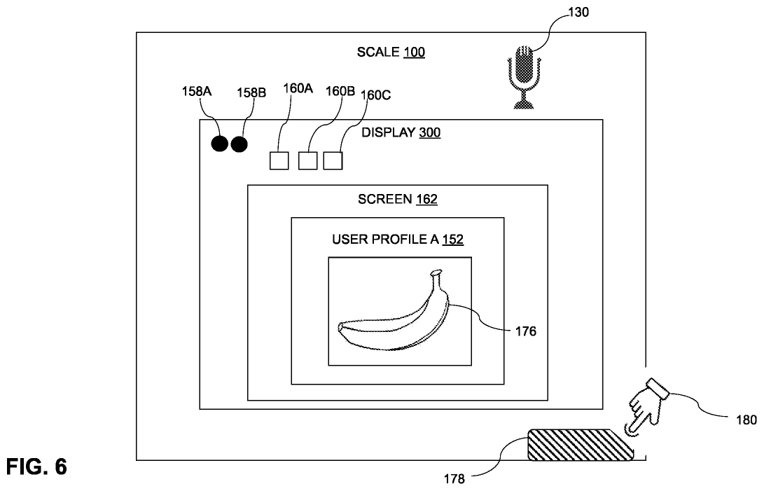

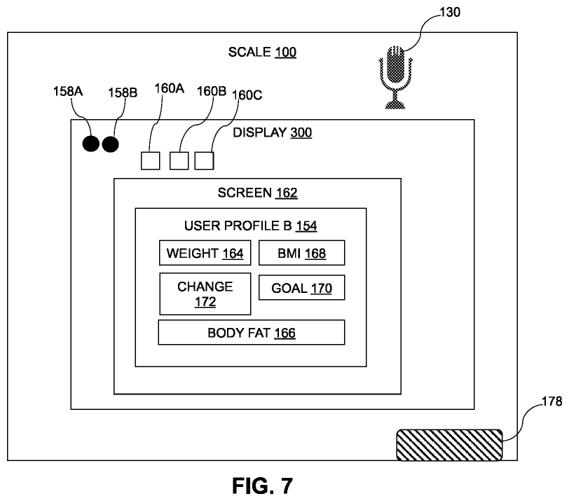

FIG. 4, FIG. 5, FIG. 6, and FIG. 7 depict schematic diagrams of an interactive display 300 for the scale 100. It should be appreciated that the interactive display 300 may have additional or fewer features from the ones described and depicted herein. In one embodiment, the interactive display 300 is touch-enabled.

The interactive display 300 allows the user to view data described herein in numerous ways. In an example, the interactive display 300 provides a screen 162 that changes based on user selection of a button, such as a first button 160A, a second button 160B, or a third button 160C. Upon user selection of the first button 160A, the screen 162 of the scale 300 displays the user profile associated with the given user. For example, as shown in FIG. 4, the screen 162 displays the first user profile A 152 of the first user that shows a current weight 164 for the given scale user, a current body fat percentage 166, a current BMI 168, the goal/target weight 170, and a change in weight 172 since the most recent user weigh-in. Other raw scale data could also be displayed.

Upon selection of the second button 160B, and as depicted in FIG. 5, the screen 162 of the scale 100 displays a graph 174 of previous weight data. Such graph 174 allows the user to view the user's change in weight over a period of time. Upon selection of the third button 160C, and as shown in FIG. 6, the screen 162 of the scale 100 displays images (such as an image 176) of foods eaten by the individual. In one example, the images are images of foods that the user has eaten within a specific time period. In an example, the images may be images received from mobile device 110 for foods eaten by the given user within the past 7 days, or past 24 hours, or other specific time period. In additional examples, other buttons may be present. For example, a message button, upon selection, may display encouraging messages via the screen 162 to the user for the user to meet the user's goal.

In another example, the scale 100 may include a switch component 178 (of FIG. 4, FIG. 5, FIG. 6, and FIG. 7). The switch component 178 may receive an action 180 (as shown in FIG. 6), such as a touch or tap action by a users' hand, finger, or foot, indicating that the first user wishes to switch display on the screen 162 to another profile or to other information.

In other examples, voice activation may be used to prompt the scale 100 to perform an action, such as display the first user profile A 152 associated with the first user or display different items or information associated with the first user profile A 152 on the screen 162. Voice activation may also be used to perform actions on the mobile device 110. As explained, the scale 100 comprises the voice activation component 124 (or module) and the mobile device 110 comprises the voice activation component 120 (or module). The voice activation component 124 may be used to control actions of the scale 100 and the voice activation component 120 may be used to control actions of the mobile device 110, respectively.

Further, the voice activation component 124 of the scale 100 comprises the one or more algorithms 184 and the voice activation component 120 of the mobile device 110 comprises the one or more algorithms 186. In an example, when the microphone 130 of the scale 100 receives an audio input from the user, the one or more algorithms 184 of the voice activation component 124 analyze the audio input to determine whether the audio input corresponds to a command recognizable by the voice activation component 124. Such recognizable commands are stored in the memory 150 of the scale 100. In other examples, the recognizable commands are stored in a data store (not shown). If the voice input corresponds to a recognizable command, the scale 100 may process and execute the command.

Similarly, when the microphone (not shown) of the mobile device 110 receives an audio input from the user, the one or more algorithms 186 of the voice activation component 120 analyze the audio input to determine whether the audio input corresponds to a command or macros recognizable by the voice activation component 120. Such recognizable commands are stored in the memory 182 or a data store (not shown) of the mobile device 110. If the voice input corresponds to a recognizable command, the mobile device 110 may process and execute the command.

The command can include any of a number of functions or operations supported by scale 100 or the mobile device 110. It should be appreciated that the recognizable commands may include: turn on the device, turn off the device, awake the device from a sleep mode, put the device into the sleep mode, display the first user profile A 152, display the second user profile B 154, display the graph 174 from the first user profile A 152 via the screen 162, display the images of food eaten by the given user within a specified time period, measure and display the current weight 164 for the given scale user, measure and display the current body fat percentage 166 for the given scale user, measure and display the current BMI 168 for the given scale user, display the goal/target weight 170 for the given user, display the change in weight 172 for the given user since the most recent user weigh-in, etc.. It should be appreciated that the scale 100 and the mobile device 110 may utilize user input devices to replace or supplement voice commands.

It should be appreciated that in some implementations, the mobile device 110 may comprise an intelligent personal assistant and knowledge manager, such as Siri, and/or a virtual assistant artificial intelligence (AI) technology developed by Amazon, Amazon Alexa. In this example, the mobile device 110 may first receive, via the data input device 114, an action on a physical button, icon, or display of the mobile device 110. In response, the mobile device 110 may launch Siri or Amazon Alexa. Then, the user may provide audio input, via the microphone, to the mobile device 110. Siri or Amazon Alexa may process the audio input and provide an audio or a visual response. In some examples, the audio or visual response may be transmitted to the scale 100 for storage and/or display to the user.

As described herein, “Siri” is a software application, and more particularly, an intelligent personal assistant and knowledge manager. Siri is part of Apple Inc.'s iOS, iPadOS, watchOS, macOS, and tvOS operating systems. The assistant uses voice queries, gesture based control, focus-tracking and a natural-language user interface to answer questions, make recommendations, and perform actions by delegating requests to a set of Internet services. The software adapts to users' individual language usages, searches, and preferences, with continuing use. Returned results are individualized. Siri supports a wide range of user commands, including performing phone actions, checking basic information, scheduling events and reminders, handling device settings, searching the Internet, navigating areas, finding information on entertainment, and is able to engage with iOS-integrated apps.

As described herein, “Amazon Alexa” or “Alexa” is a virtual assistant AI technology developed by Amazon. Alexa is capable of voice interaction, music playback, making to-do lists, setting alarms, streaming podcasts, playing audiobooks, and providing weather, traffic, sports, and other real-time information, such as news. Alexa can also control several smart devices using itself as a home automation system. Users are able to extend the Alexa capabilities by installing “skills” (additional functionality developed by third-party vendors, in other settings more commonly called apps such as weather programs and audio features).

Moreover, the display 300 of the scale 100, as shown in FIG. 4, FIG. 5, FIG. 6, and FIG. 7, may also include one or more indicators 158A, 158B to remind an individual to weigh-in on the scale 100 and to provide a means for driving adherence of scale use. Further, in examples, the one or more indicators 158A, 158B may be one or more light-emitting diodes (LEDs) of various colors. The one or more indicators 158A, 158B may be used in a number of ways.

The one or more indicators 158A, 158B may flash, strobe, or change color. In another example, the first user associated with the first user profile A 152 may be assigned a color of green and the second user associated with the second user profile B 154 may be assigned a color of red. Such colors may be stored in the respective user profile. If the first user, for example, fails to use the scale for more than a specified time period (e.g., a week), the one or more indicators 158A, 158B may flash the color green at a low duty-cycle. In the same example, if the second user fails to use the scale for more than a specified time period, the one or more indicators 158A, 158B may flash the color red at a low duty-cycle. The duty-cycle may increase successively as more time elapses between consecutive weigh-ins by the scale user.

In an alternate configuration, the one or more indicators 158A, 158B may appear as a first color for the given user when the individual is weighed on the scale. After a predetermined amount of time, if the user has not used the scale, the one or more indicators 158A, 158B may change to a second color. Later, if the user has not used the scale after a second predetermined time, the one or more indicators 158A, 158B would change to a third color.

In this example, the one or more indicators 158A, 158B may initially appear green in color to the first user when the individual is weighed on the scale. After a predetermined amount of time (e.g., a week), if the first user has not used the scale, the one or more indicators 158A, 158B change from the green color to a gray color. Later, if the first user has not used the scale after a second predetermined time (e.g., a month), the one or more indicators 158A, 158B would change from the second color of gray to a third color, black.

In one embodiment, the mobile device 110 may send a user-identifying signal to the scale 100 when the mobile device 110 is in proximity to scale 100. In an alternate embodiment, the one or more indicators 158A, 158B may also include audio indicators. In this embodiment, the one or more indicators 158A, 158B illuminate or sound (e.g., a tone, a beep, an alarm, etc.) when mobile device 110 is in proximity to the scale 100.

Furthermore, as depicted in at least FIG. 4, FIG. 5, FIG. 6, and FIG. 7, the one or more indicators 158A, 158B are located on a same surface as the display 300. In another example, the one or more indicators 158A, 158B may be located on a different surface of the scale 100, such that the one or more indicators 158A, 158B face the ground when the scale 100 is in use. In this example, when on, the one or more indicators 158A, 158B may create light around the bottom of the scale 300. In a further example, the one or more indicators 158A, 158B may be located around the periphery of the scale 100. In this example, if the periphery of the scale 100 were glowing green, the first user associated with the green color would know that it is time to use the scale 100.

If a predetermined amount of time has passed (e.g., a week), the color of the one or more indicators 158A, 158B may pulse to indicate that it has been longer than the predetermined amount of time since the given user has taken a measurement using the scale 100. The pulse could then turn into an on-off flashing pattern after a longer period of time has elapsed (e.g., two weeks). In an embodiment, if the user utilizes the key fob to communicate to the scale 100 that the user is present, the one or more indicators 158A, 158B may increase light intensity for the user identified by the key fob.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system comprising:
a network;
a body weight scale comprising:
a load sensor configured to capture a body weight of an individual;
an analog-to-digital converter configured to convert the body weight of the individual to a digital weight;
one or more sensors configured to measure biometric parameters of the individual;
a wireless communication interface configured to provide data communication connectivity to the network;
a central computer processor (CPU) connected to a memory, the memory being configured to house a first user profile associated with a first user and a second user profile associated with a second user;
a display configured to display information to the individual;
a microphone configured to receive an audio input from the individual; and
a voice activation component comprising one or more algorithms, the one or more algorithms being configured to:
analyze the audio input received via the microphone;
compare the audio input to commands stored in the memory;
determine that the audio input corresponds to a command of the commands stored in the memory based on the comparison; and
process and execute the command; and
a mobile device configured to interact with the scale via the network.

2. The system of claim 1, wherein the scale further comprises:
a data input device configured to receive a physical input from the individual.

3. The system of claim 1, wherein, in response to obtaining the digital weight of the individual, the body weight scale is configured to:
compare the digital weight of the individual to a first group of weights associated with the first user profile; and
compare the digital weight of the individual to a second group of weights associated with the second user profile.

4. The system of claim 3, wherein, in response to obtaining the digital weight of the individual, the body weight scale is configured to:
determine that the digital weight is closer to the first group of weights associated with the first user profile of the first user; and
predict the individual as being the first user.

5. The system of claim 1, wherein the mobile device is configured to:
send a signal via the network to the scale when the mobile device is in proximity to the scale.

6. The system of claim 5, wherein the scale is configured to:
receive the signal from mobile device;
select a weight log corresponding to an owner of the mobile device; and
store the digital weight of the individual in the first user profile if the owner of the mobile device is the first user or store the digital weight of the individual in the second user profile if the owner of the mobile device is the second user.

7. The system of claim 1, further comprising:
a key fob that contains wireless signal capabilities, wherein the key fob is configured to transmit a signal to the scale when the key fob is in proximity of the scale.

8. The system of claim 7, wherein the scale is configured to:
receive the signal from the key fob;
select a weight log corresponding to an owner of the key fob; and
store the digital weight of the individual in the first user profile if the owner of the key fob is the first user or store the digital weight of the individual in the second user profile if the owner of the key fob is the second user.

9. The system of claim 1, wherein each of the first user profile and the second user profile comprise a weight log, images of food eaten by the first user or the second user in a given time period, and a unique identifier for the first user or the second user.

10. The system of claim 9, wherein the weight log comprises a weight of the first user or the second user, an age of the first user or the second user, a height of the first user or the second user, an amount of body fat of the first user or the second user, a body mass index (BMI) of the of the first user or the second user, a goal or target weight of the first user or the second user, and a weigh-in date and time of the first user or the second user.

11. The system of claim 1,
wherein the mobile device comprises a nutrition software application executed on the mobile device, and
wherein the nutrition software application is configured to track food data, weight data, and physical activity data of the individual.

12. A body weight scale comprising:
a load sensor configured to capture a body weight of an individual;
an analog-to-digital converter configured to convert the body weight of the individual to a digital weight;
one or more sensors configured to measure biometric parameters of the individual;
a wireless communication interface configured to provide data communication connectivity to a network;
a central computer processor (CPU) connected to a memory, the memory being configured to house a first user profile associated with a first user and a second user profile associated with a second user;
a display configured to display information to the individual;
a microphone configured to receive an audio input from the individual, wherein the audio input comprises login credentials; and
a voice activation component comprising one or more algorithms, the one or more algorithms being configured to:
analyze the login credentials of the individual received via the microphone;
compare the login credentials of the individual to a first set of login credentials associated with the first user profile of the first user;
compare the login credentials of the individual to a second set of login credentials associated with the second user profile of the second user;
determine that the login credentials of the individual match the first set of login credentials associated with the first user profile of the first user; and
confirm the identity of the individual as being the first user.

13. The body weight scale of claim 12, wherein the body weight scale is configured to communicate with a mobile device via the network.

14. The body weight scale of claim 12, wherein each of the first user profile and the second user profile comprise a weight log, images of food eaten by the first user or the second user in a given time period, and a unique identifier for the first user or the second user.

15. The body weight scale of claim 14, wherein the weight log comprises a weight of the first user or the second user, an age of the first user or the second user, a height of the first user or the second user, an amount of body fat of the first user or the second user, a body mass index (BMI) of the of the first user or the second user, a goal or target weight of the first user or the second user, and a weigh-in date and time of the first user or the second user.

16. The body weight scale of claim 12, further comprising:
one or more indicators configured to drive adherence of scale use.

17. The body weight scale of claim 16, wherein each of the one or more indicators comprise a light-emitting diode (LED).

18. The body weight scale of claim 16,
wherein the first user is associated with a first color of light configured to be emitted from the one or more indicators,
wherein the second user is associated with a second color of light configured to be emitted from the one or more indicators,
wherein the first color of light differs from the second color of light,
wherein the first color of light is stored in the first user profile, and
wherein the second color of light is stored in the second user profile.

19. The body weight scale of claim 18,
wherein the one or more indicators are configured to project or flash the first color of light if the first user fails to use the body weight scale for a predetermined period of time, and
wherein the one or more indicators are configured to project or flash the second color of light if the second user fails to use the body weight scale for the predetermined period of time.

20. The body weight scale of claim 16, wherein the one or more indicators comprise an audio functionality such that the one or more indicators project or flash light and/or emanate a sound when the individual is within a proximity of the scale.
